(19) United States
(12) Patent Application Publication
(10) Pub. No.: US 2019/0210864 A1
(43) Pub. Date: Jul. 11, 2019

(54) WHOLESALE FUEL DISCOUNT SYSTEM

(71) Applicant: Michael A. Racusin, Chicago, IL (US)

(72) Inventor: Michael A. Racusin, Chicago, IL (US)

(21) Appl. No.: 15/865,891

(22) Filed: Jan. 9, 2018

(51) Int. Cl. B67D 7/30; G06Q 20/28; G06Q 20/14; B67D 7/14

(52) U.S. Cl. CPC B67D 7/303; B67D 7/305; G06Q 30/0207; G06Q 20/145; B67D 7/14; G06Q 20/28

(57) ABSTRACT

An improved control system for a fuel dispenser solves the problems of the prior art by enabling processing of prepaid fuel discount cards that discount only the wholesale price component of the per unit retail fuel price. The control system recalculates the per unit retail price based upon the applied discount. Upon purchase of the prepaid fuel discount card, a snapshot of the wholesale price components is taken of all fuel dispensers in a region and locked in for the purchaser at the time of purchase of the prepaid discount fuel card. A central server performs “back office” processing and recalculates the retail per unit price of fuel at the time of delivery of the fuel based upon a discount applied to the per unit wholesale price component for the fuel dispenser location where the fuel is being delivered. With the novel system disclosed herein, the wholesaler can control the amount of the discounts applied to the retail unit price of fuel. The system enables the wholesaler to create an elastic demand for the fuel and regain customer loyalty for fuel credit cards. Initially the purchaser deposits an initial amount of money in the account. The average weighted wholesale price per gallon is determined after each deposit is made. The average weighted wholesale price is used to pay for delivery of gasoline.

### BACKGROUND OF THE INVENTION

### 1. Field of the Invention

The present system relates to a fuel dispenser that can process discounts on the retail price per gallon of gasoline in which only the wholesale price component is discounted.

### 2. Description of the Prior Art

Fuel dispensers are known to be used to dispense various types of fuel, such as regular, mid-range and premium grades of gasoline, and diesel fuel. Examples of such fuel dispensers are disclosed in U.S. Pat. Nos. 9,302,899; 9,139,414; and 9,082,248, hereby incorporated by reference.

Such fuel dispensers include two main systems; an electronic control system and a mechanical system. The mechanical system is in fluid communication with a fuel tank, for example, an underground fuel tank. Both the electronic control system and the mechanical system are carried by a free-standing housing.

The mechanical system generally includes an electric motor, a pump and one or more electrically controlled valves required to control the fuel flow. The electric motor and electrically controlled valves are under the control of the electronic system. The mechanical system also includes a manual valve operated by the purchaser that controls the fuel flow when the mechanical system is enabled. A nozzle is connected to the pump with a hose. The nozzle is carried by a handle that includes the manually operated valve operated by way of a pivotally mounted lever attached to the handle. The lever allows a purchaser to control the gas flow from the nozzle by way of the lever. When not in use, the handle and nozzle are carried by a holster rigidly attached to the fuel dispenser housing. The holster is known to include an indication that the transaction has completed, such as a mechanically operated switch. Known indications use a manually operated lever that needs to be manually operated by the purchaser before the handle and nozzle can be hung up in the holster. Other means for indicating the completion of the transaction are also known.

The electronic control system includes an embedded computer processing unit (CPU) that controls the operation of the electric motor driving the pump and the electrically controlled valves. The electronic control system also includes displays for indicating the price per gallon of a selected grade of fuel, a magnetic card reader for receiving a purchaser's credit card and a bi-directional communication system for communicating with credit card companies relating to the payment of retail sales.

Typically, a retail customer swipes a credit card through a magnetic card reader located on the fuel dispenser housing. The electronic control system reads the data on the magnetic strip on the credit card and checks the customer's available credit in the purchaser's account by way of the bi-directional communication system. Once the purchaser's account balance has been verified, the electronic control system enables the electric motor that drives the pump and the electrically controlled valves and enables the fuel flow to be manually controlled by the lever in the handle.

In addition to accepting credit cards, known fuel dispensers are known to provide fuel discounts based upon purchaser loyalty cards when such purchaser loyalty cards are read by the magnetic card reader in addition to the purchaser's credit card. These discounts are normally provided at the fuel dispenser in the form of a reduced retail price per gallon.

Cash reward credit cards are also known. With such cash reward cards, a statement credit is provided on the purchaser's statement for all fuel and other purchases made with the credit card.

One problem with such loyalty cards and cash reward credit cards is that the discount normally applies to the entire retail gas price. However, the discount cannot be applied to the local tax component. The per unit retail fuel price is comprised of multiple components; wholesale price component+a local tax component and a local fee component. The local fee component includes owner profit and various other fees and costs, and other charges associated with the location of the retail fuel station. The tax component includes federal, state and local taxes based upon the location of the fuel dispenser. Each of these components is known to vary as a function of the geographic location of the fuel dispenser. Because of these variances and since discounts cannot be applied to taxes, the use of fuel discounts that apply to the entire retail per unit price of fuel are known to be very small or limited to a specific region where the local fee and local tax components as well as the wholesale price components are constant.

Prepaid fuel cards are also known which normally provide a fixed price on the entire unit price of fuel. These prepaid cards are of little value to wholesalers, such as gasoline companies like Shell, Exxon, BP and the like, because wholesalers operate over a region where the wholesale price components and other price components making up the per unit retail fuel price vary. For example, as illustrated in FIGS. 5A and 5B, the wholesale fuel prices vary by location. Since wholesalers operate in regions in which there are multiple wholesale gas prices, such prepaid fuel cards have been of little interest to wholesalers. This is due to the inability of the wholesaler to provide a uniform discount on the wholesale gas component of the per unit fuel price in an entire region in which various price components vary.

One attempt to solve this problem is disclosed in Wanasek US Patent Application Publication No. US 2004/0260632 A1 (“Wanasek”). Wanasek discloses a prepaid commodity card in which several gallons of fuel can be pre-purchased from a wholesaler at a fixed per unit wholesale cost without taking delivery. The Wanasek system is not viable. One reason is that there are no known fuel dispensers that can process such a discount card. Since the currency of Wanasek card is gallons, transactions would need to be handled by an attendant. Also, local fees and local taxes would need to be determined by the attendant and handled in a separate transaction. Another problem is that a separate card would be required for each grade of gasoline, i.e., premium, mid-range, regular and diesel because their prices are different and independent. As, such, wholesalers have not been known to have any interest in such a prepaid commodity card.

Another problem with the methodology disclosed in Wanasek is that it is based on a specified per unit wholesale component price. As published by the National Association of Convenience Stores (NACS), 65% of the price of a gallon of gas is based on the cost of crude oil. (see www.nacsonline.com/YourBusiness/FuelsCenter/Basics/Articles/Pages/The-Price-Per-Gallon.aspx). As illustrated in FIGS. 5A and 5B, there is a wide variance in crude oil prices in different regions across the US which would have a significant impact on the regional wholesale unit gasoline price. Since the Wanasek card is based upon a specified wholesale component price, the Wanasek card could only be used in a limited area where the wholesale component price is the same. For example, if a user purchased a Wanasek commodity card in a region where the crude oil price was $17.38 per barrel, say West Virginia, unless the fuel discount card was geographically constrained, the card could theoretically be used in a region, such as Louisiana, where the price per barrel of crude is $28.10 per barrel. The Wanasek cards would thus need to be constrained to locations where wholesale cost is constant and matched. This would be would be difficult if not impossible to administer by wholesalers.

In general, known fuel discount cards are not useful to wholesalers that operate over a large region, such as the US, since wholesale prices, local taxes and local fees per unit vary by location. Since taxes cannot be discounted, the discount would need to be apportioned between the other per unit price components; namely the per unit wholesale fuel price and the per unit local fees. Since the per unit local fees and local taxes, as well as the per unit wholesale price components vary by location, it would be virtually impossible for a wholesaler to administer a uniform discount on the wholesale price component of the per unit price of fuel.

Thus, there is a need for a fuel dispenser that is configured to process prepaid fuel discount cards based only upon a discounted wholesale price component.

### SUMMARY OF THE INVENTION

A fuel dispenser that solves the problems of the prior art by enabling a fuel dispenser to process prepaid fuel discount cards in which the discount is only applied to the wholesale price components of the per unit retail fuel price. The system recalculates the per unit retail price based upon the discounted wholesale price components. Upon purchase of the prepaid fuel discount card, a snapshot of the wholesale price components is taken of all fuel dispensers in a region and locked in for the purchaser at the time of purchase of the prepaid discount fuel card for delivery later. When a purchaser takes delivery of gasoline, a central server performs “back office” processing and recalculates the retail per unit price of fuel at the time of delivery of the fuel based upon wholesale price component discount for the fuel dispenser location where the fuel is being delivered. The system automatically debits the purchaser's prepaid account for the fuel purchased at the discounted retail price based upon a weighted average of the discounted wholesale price component of different prepayments at different times which may be at different wholesale discounts. With the novel system disclosed herein, the wholesaler can control and keep track of the amount of the discounts applied to the retail unit price of fuel. Using the discounts, the wholesaler, i.e. gasoline company, can create an elastic demand for the fuel by raising the discount to generate additional sales and lower the discount to lower the sales volume. The wholesale discount system allows gasoline companies to re-popularize gas cards sponsored by gasoline companies which may help regain customer loyalty for fuel credit cards.

### DESCRIPTION OF THE DRAWING

These and other advantages of the present invention will be readily understood with reference to the following specification and attached drawing wherein:

FIG. 1A is an elevation view of an exemplary fuel dispenser.

FIG. 1B is a block diagram illustrating the data flow between the fuel dispenser illustrated in FIG. 1 and a remote server.

FIG. 2 is a block diagram of an exemplary system for implementing the fuel dispensers disclosed herein.

FIG. 3A is an exemplary flow chart for the fuel dispenser disclosed herein.

FIGS. 3B and 3C illustrate an exemplary flow chart for the remote server described herein.

FIG. 4A is an exemplary flow chart that illustrates setting up an initial account.

FIG. 4B is an exemplary flow chart that illustrates accessing an existing account.

FIGS. 5A and 5B illustrate a Table of wholesale gas prices in various locations at a fixed point of time.

### DETAILED DESCRIPTION

An improved control system for a fuel dispenser solves the problems of the prior art by providing a control system for a fuel dispenser that can process prepaid fuel discount cards that discount only the wholesale price component of the per unit retail fuel price. The system recalculates the per unit retail price based upon the applied discount. Upon purchase of the prepaid fuel discount card, a snapshot of the wholesale price components is taken of all fuel dispensers in a region, for example, the US, at the time of purchase of the prepaid fuel discount card or another specified time that are locked in for the purchaser at that time. Initially the purchaser deposits an initial amount of money in the account.

When a purchaser takes delivery of gasoline, the fuel dispenser reads the purchaser's account data on a prepaid fuel discount card and transmits the data to a central server along with the location of the fuel dispenser, the grade of gasoline selected, the current per unit retail price and the number of units pumped. The central server performs “back office” processing and determines a weighted average of the discounted wholesale price component of different prepayments at different times which may be at different wholesale discounts. The central server determines the discounted per unit retail price at the time of delivery based upon that weighted average and determines a maximum number of units that can be pumped based upon the discounted per unit retail price and the purchaser's account balance. The central server sends an enable signal to the fuel dispenser to enable fuel to be pumped up to the maximum number calculated. Once the transaction is complete or the maximum number of units has been pumped, the central server disables the pump and debits the purchaser's account.

At the time of purchase of the prepaid fuel discount card, the central server takes a snap shot of the wholesale price components existing at all fuel dispensers across an entire region or at a specified time. The snapshot locks in the wholesale price components for the purchaser existing at fuel dispensers across the region. The percentage discount is then applied to the locked in wholesale price components at the location of the fuel dispenser where the fuel is delivered. With a fixed discount on the wholesale price components in effect at the time of purchase of the prepaid fuel discount card, a wholesaler can determine and control the discount being applied to the wholesale price components of the per unit retail fuel price across a region.

The novel system provides various advantages to wholesalers heretofore unknown. For example, a wholesaler can keep track of the aggregate amount of wholesale price component discounts over a given period by multiplying the wholesale component discounts by the number of gallons at a discounted wholesale price component. The novel system allows a wholesaler to increase the discount to increase demand or lower the discount to lower the demand thus creating an elastic demand for the fuel.

The system recalculates a discounted retail unit fuel price based upon a weighted average of the discounted wholesale price components associated with different prepayments by the purchaser at different wholesale price component discounts. The discounted unit retail price at the time of delivery is determined by subtracting the undiscounted wholesale price component at the time of purchase of the prepaid fuel discount card from the undiscounted retail price at the time of delivery and adding the discounted retail price component at the time of delivery.

The discounted unit retail price is determined as shown below.
Undiscounted retail unit price=undiscounted unit wholesale price component+local fees+local taxes
Undiscounted retail unit price−undiscounted wholesale price component=local cost and local taxes
Discounted retail unit fuel price=undiscounted retail unit fuel price−undiscounted wholesale price component+average weighted discounted wholesale price component

As used herein, the following definitions apply:
Undiscounted wholesale gas price component is the wholesale component of the retail price of a gallon of fuel at a given location.
Retail gas price is the price that a retailer sells a gallon of fuel to a customer at a given location.
Discounted wholesale price component: is the discounted wholesale price component of the retail fuel price based upon a discount applied to all regional wholesale unit fuel component prices in a region of interest, i.e. US, or other smaller regions, such as the state of Illinois, at the time of purchase of the prepaid gas card. The wholesale fuel component is based upon the price a retail gas station owner pays to a wholesale supplier.
Average weighted wholesale price component is the weighted average of the wholesale price component based upon different prepayments by the purchaser at different times at the wholesale price components existing at the time of the prepayment.

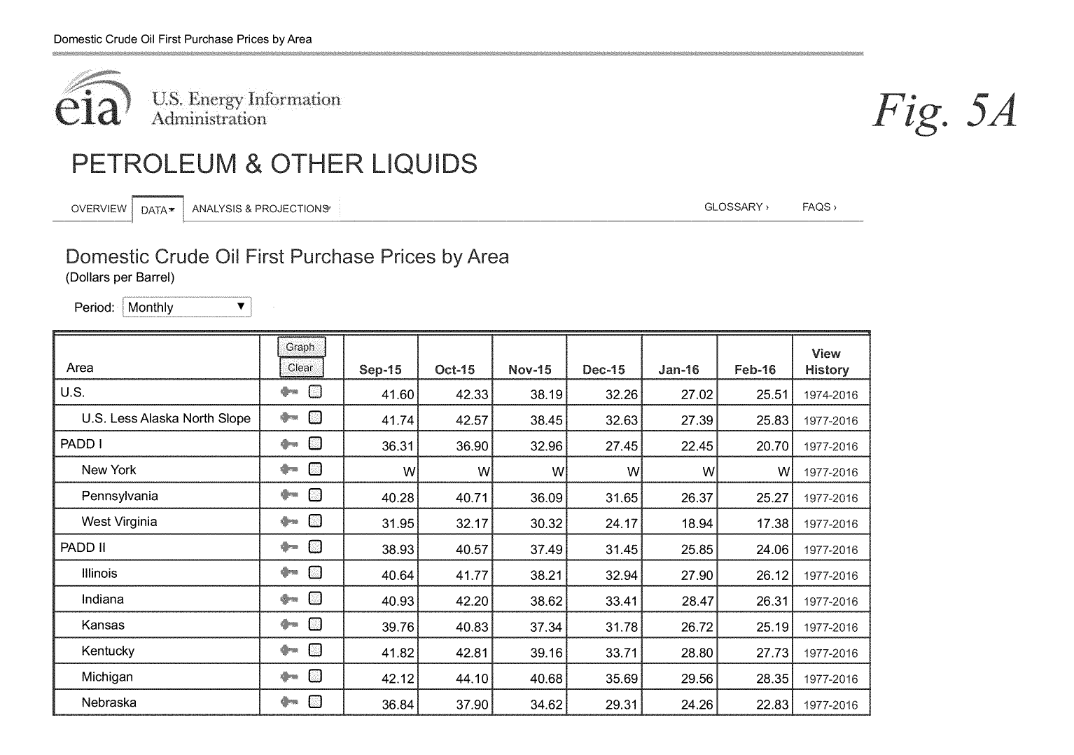

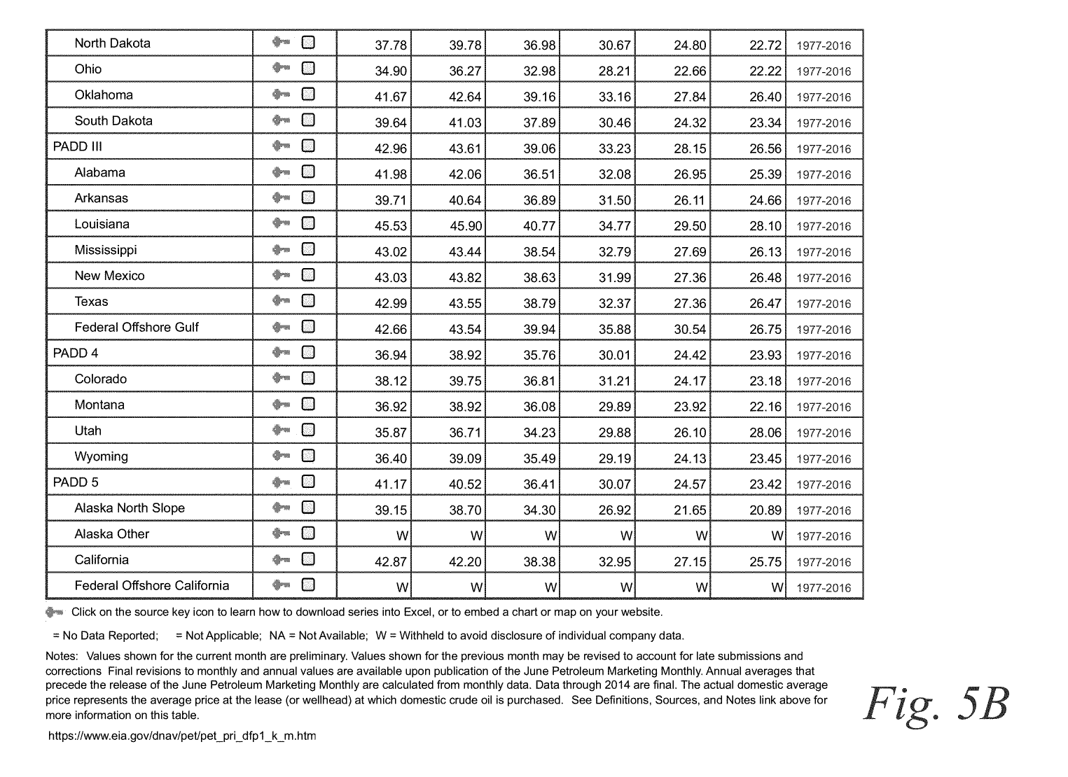

As illustrated in FIGS. 5A and 5B, wholesale fuel prices vary by location and gasoline type. Local taxes relate to the federal, state and local taxes per gallon which also vary by location. Local fees include various components including the retail owner's expenses and margin also vary by location.

To provide a discount on the wholesale price components on the retail price of a gallon of fuel, the retail price must be recalculated. The enhanced functionality of the fuel dispenser is based upon “back office” processing by a remote central server that automatically recalculates retail fuel price per gallon based upon a weighted average of the wholesale price component.

Various options are contemplated for each discount. For example, the discount may be fixed, variable or graduated and may be different in different parts of the region. For example, the prepaid fuel discount card can be a percentage discount on the wholesale discount component of the unit retail fuel price at the time of purchase of the card or alternatively a fixed or variable percentage discount, for example 10%, at a specified point in time.

An important aspect of one embodiment of the invention relates to the snap shot of all wholesale price components at the time of purchase of the discount fuel card existing in an entire region, such as the US, before a discount is taken. Those wholesale price components are locked in for the purchaser for the entire balance on the card. The discount is applied at the time of fuel delivery to the locked in wholesale price component existing at the location of delivery at the time of the snapshot.

With the discount discussed above, the fuel cost will vary at different locations based upon the differences in the wholesale fuel costs, local fees and local taxes. For example, assume the purchaser purchases a prepaid fuel card based upon a single prepayment of $1000. Assume the purchaser takes delivery of 10 gallons of fuel at a location where the undiscounted retail premium price per gallon is $3.50 and the undiscounted premium wholesale price component at that location is $2.50 per gallon at the time of the snapshot and the local fees and taxes are $1.00 per gallon. With a 10% discount on the wholesale price component, the discounted retail price would be 10×(2.25+1.00) or 32.50. This amount would be debited from the purchaser's balance on the prepaid fuel card leaving a $967.50 credit balance on the prepaid gas card.

Now assume that the purchaser goes to another locale to take delivery of 10 more gallons of gas where the undiscounted premium retail price per gallon is $2.50 per gallon and the local taxes and local fees are $0.50 per gallon and the wholesale premium price component at the time of purchase of the prepaid discount fuel card is $2.00 per gallon. Applying the same 10% discount to the wholesale price component at the time of the snap shot, the purchaser's account would be debited for another 10×($1.80+$$0.50) or $23.00 leaving the purchaser with a credit balance of 944.50.

The wholesale fuel discount system may be used in various applications for purchasing one or more of the following items:
diesel fuel
regular grade fuel
midrange grade fuel
premium grade fuel

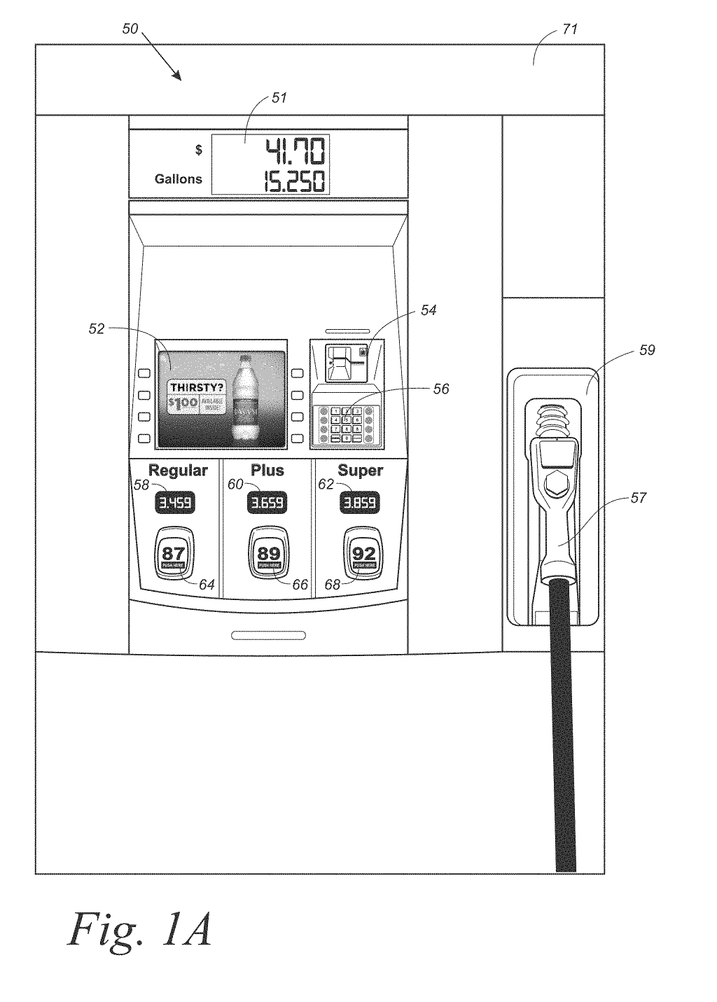

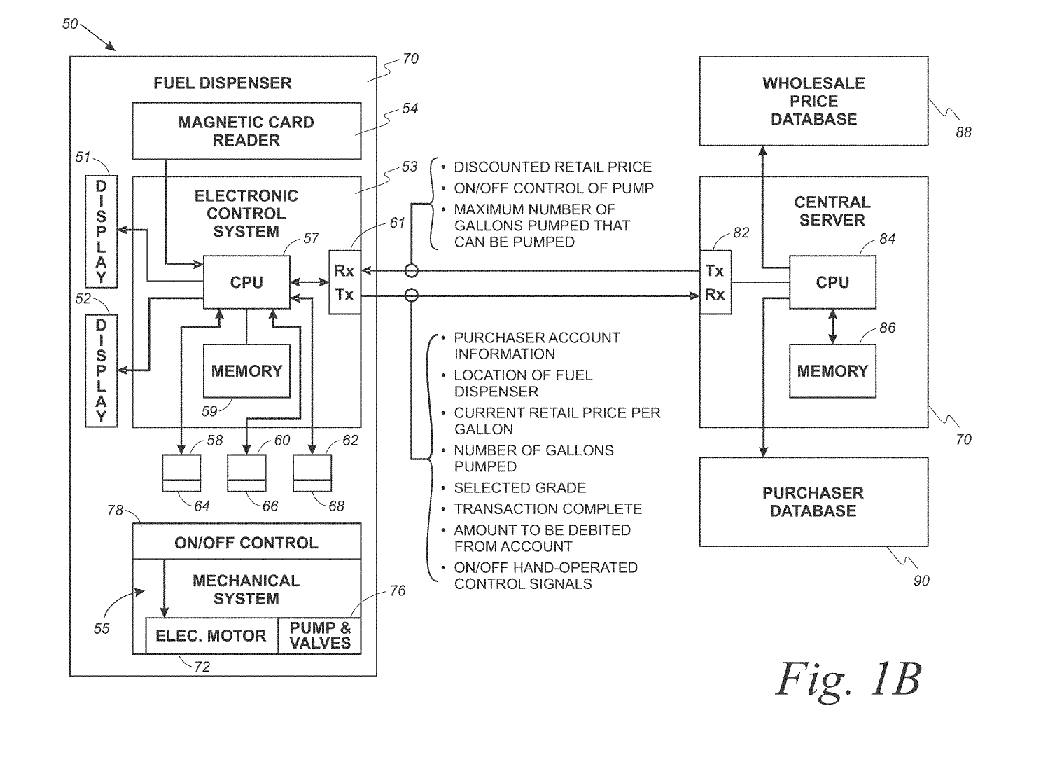

An exemplary fuel dispenser is illustrated in FIGS. 1A and 1B. The fuel dispenser, generally identified with the reference numeral 50, includes an electronic control system 53 and a mechanical system 55, mounted within a housing 71.

The fuel dispenser 50 includes a main display 51 (FIG. 1A) for displaying the number of gallons pumped and the total price for the gallons of fuel pumped. An optional supplemental display 52 may also be provided for advertising goods for sale at the station. Price displays 58, 60 and 62 provide the fuel price per gallon of the available grades of fuel available for selection. A plurality of paddle switches 64, 66 and 68, typically for 87, 89 and 93 octane gasoline, are provided to enable selection of the desired grade of fuel. The displays 51, 52, 58, 60 and 62 are mounted to a front panel of the housing 71.

The fuel dispenser 50 also includes input devices. A magnetic card reader 54 is provided for reading from a magnetic strip on the back of a prepaid discount fuel card or an embedded chip. The magnetic strip or embedded chip is in encoded with a purchaser's account information. Biometric readers, such as fingerprint readers are also contemplated. A keyboard 56 is provided for typing in passwords, such as zip codes.

The electronic control system 53 includes a computer processing unit (CPU) or microcontroller 57 (FIG. 1B) and memory 59 which may include persistent memory as well as random access memory (RAM). The electronic control system 53 also includes a transceiver 61 for providing a bidirectional communication path with a remote server 70.

The mechanical system 55 includes an electric motor 72, a pump 74 and an on/off control system 78. The electric motor 72 and the electrically controlled valves 76 are responsive to an enable and disable a signal from the on/off control subsystem 78. Once the electric motor 72 and electrically controlled valves 76 are enabled by way of the on/off control subsystem 78, fuel flow is enabled under the control of the manually actuated lever in the handle 57, as discussed above.

All components of the fuel dispenser 50 are carried by a common free-standing housing 71. The fuel dispenser 50 may incorporate similar mechanical and electric hardware as disclosed in U.S. Pat. Nos. 7,948,376; 9,302,899; 9,139,414; and 9,082,248, hereby incorporated by reference.

Referring again to FIG. 1B, a block diagram of the central server 70 is illustrated. The central server 70 includes a transceiver 82 for communicating with the transceiver 61 on the fuel dispenser 50. It is to be understood that the communication between the fuel dispenser 50 and the central server 70 may not be direct as shown. For example, the communication path may include a transceiver (not shown) in the fuel station which intermediates communications between the fuel dispensers and the central server. The fuel station may include a transceiver for receiving all communications from the various fuel dispensers and transmitting those communications to the central server. Similarly, communications received from the central server 70 received by the transceiver in the fuel station may be re-transmitted to the individual fuel dispensers. Other communication configurations are contemplated. The direct communication path illustrated in FIG. 1B between the fuel dispenser 50 and the central server is provided for simplicity.

The central server 70 includes a CPU or microcontroller 84 and memory 86, such as RAM memory and persistent memory. The central server 70 is provided with access to a wholesale price database 88 and a purchaser's account database 90.

The wholesale price database 88 includes the snapshot of all the wholesale price components applicable to all fuel dispensers in a region, existing at the time of purchase of the prepaid fuel discount card or at a specified time. The purchasers account database 90 includes at least the accounts of all participating purchasers, the amount of their prepayments, their current balance and the amount and type of the discount, as well as their current account allocation, as discussed below. The databases 88 and 90 may be part of the central server 70 or may be remote and connected to the central server 70 by various communication networks, such as the Internet, cellular or other networks.

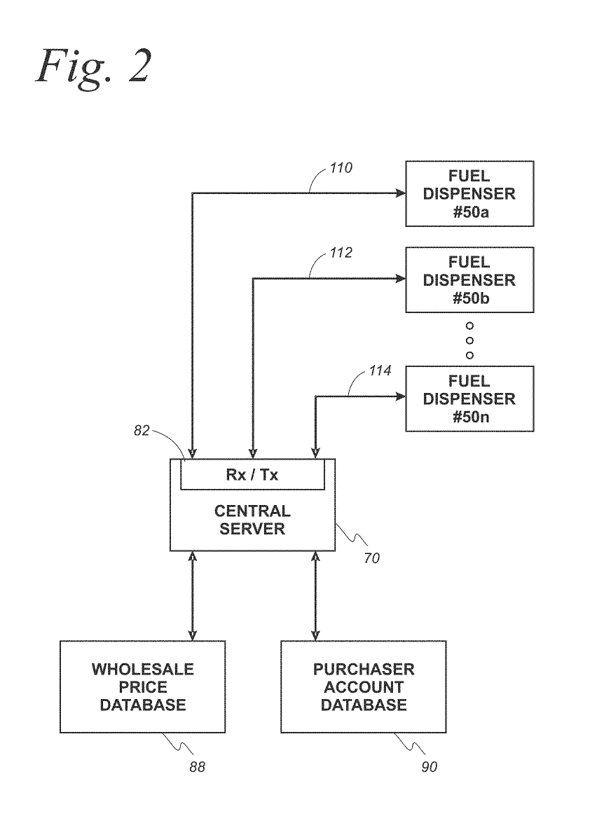

Referring to FIG. 2, the remote central server 102 is configured to receive data from a plurality of retail fuel dispensers 50a, 50b . . . 50n, located, for example, in different geographical areas in which the local fees and local taxes as well as differences in wholesale unit gasoline prices may be different. The fuel dispensers 50a, 50b . . . 50n may be connected to the central server 102 by way of a plurality of conventional communication links 110, 112 and 114, respectively, which may be virtually any conventional wired or wireless communication link that enable bi-directional communication between the central server 102 and the fuel dispensers 50a, 50b . . . 50n.

Each fuel dispenser 50a, 50b . . . 50n may transmit the following data to the central server 70:
Location of the fuel dispenser
Current retail price per gallon of the selected grade (if not available already at the central server 70)
Transaction complete signal
Number of gallons pumped
Purchaser account data
On/off control signals for enabling and disabling the electric motor 72 (FIG. 1B) and electrically controlled valves 76.
Selected grade

In return, the central server 70 recalculates the retail fuel price per gallon based upon a discount applied to the wholesale price component existing at the fuel dispenser where delivery is taken at the time the prepaid fuel discount card is purchased. The central server 70 calculates the maximum number of gallons that can be pumped based upon the recalculated retail price per gallon and the current balance in the purchaser's account. The central server 70 transmits the following data to the fuel dispenser 50a, 50b . . . 50n, where delivery is taken:
On/off control of the pump
Maximum number of gallons that can be pumped based upon purchaser's account balance and discounted retail price per gallon.
Optionally, the central server 70 may transmit the discounted retail price for display on the displays 58, 60 and 62 (FIG. 1A) and the total price of the transaction based upon the discounted retail price.

The discounted retail price per gallon may be used to the drive various displays on the fuel dispensers 50a, 50b . . . 50n including the retail price per gallon displays 58, 60 and 62 for the various grades of fuel as well as the display 51 that displays the number of gallons pumped and the total cost therefor.

Based upon the purchaser's available account balance or available credit, the central server 102 determines the maximum number of gallons that can be dispensed based upon the discounted retail gas price and enables the electric motor 72 and the electrically controlled valves to be enabled under the control of the hand-operated lever in the nozzle up to the maximum number of units of fuel calculated, as discussed above. Should the maximum number of gallons be reached before the hand operated lever in the nozzle is released, the central server 70 will send an off signal to the on/off control 78 to turn off the pump 74 off at the maximum number. Alternatively, the pump 74 is turned off when the desired number of gallons is reached, or the purchaser's tank is full.

After the gasoline dispensing is terminated either by the purchaser or automatically when the purchaser's gas tank is full or when the maximum number of gallons is reached, the fuel dispenser 50a, 50b . . . 50n may send a transaction complete signal back to the central server 102. Upon receipt of that signal, the central server 102 adjusts the purchaser's account balance based upon the number of gallons pumped and the recalculated unit retail price. The revised balance is stored by the central server 102 in the purchaser's account database 90 (FIG. 1B).

The purchaser's account is subsequently debited for the discounted number of gallons pumped. In one embodiment, the discount is displayed at the pump in the price per gallon and the total transaction price during the transaction. In an alternative embodiment, the undiscounted unit retail price and the undiscounted total transaction price are displayed at the pump during the transaction. In latter embodiments, the discount is only reflected on the purchaser's account.

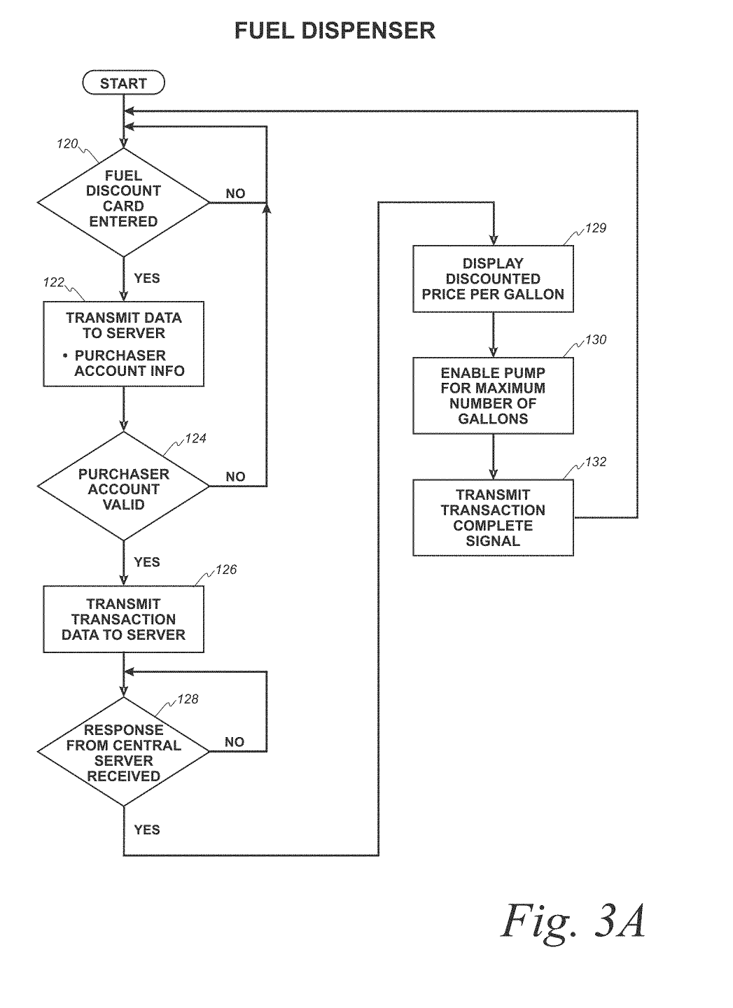

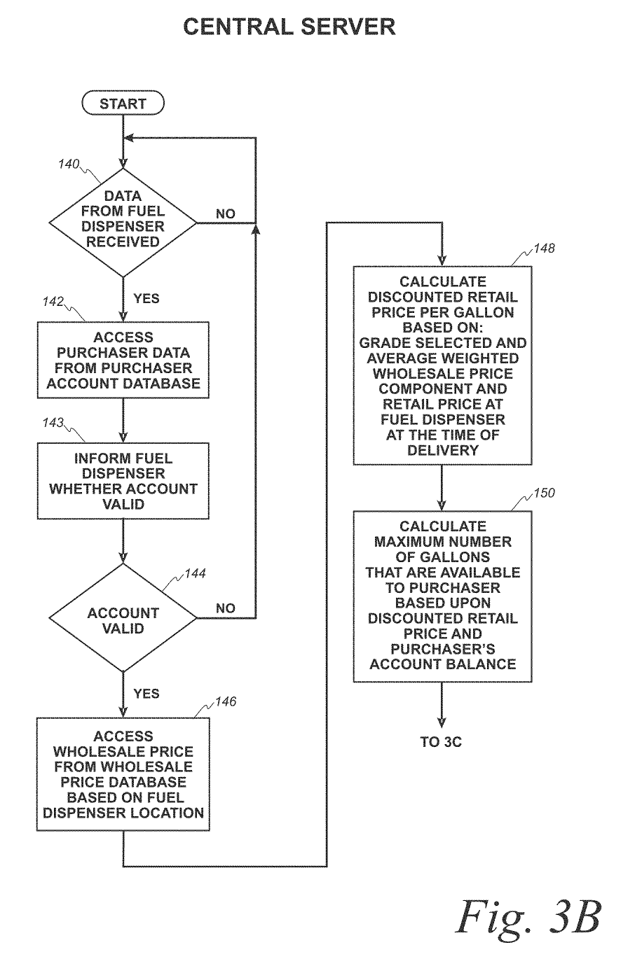

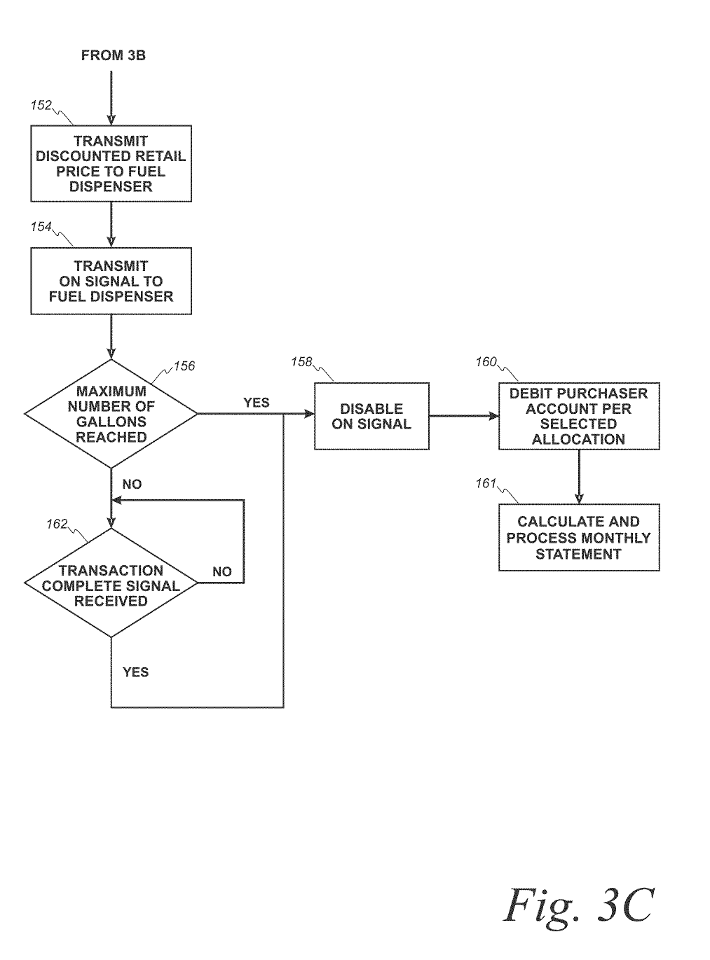

An exemplary flow chart for a fuel dispenser 50a, 50b . . . 50n is illustrated in FIG. 3A. An exemplary flow chart for the central server 70 is illustrated in FIG. 3B. It is to be understood that the improved functionality of the fuel dispenser 50 is not limited to the sequence of steps set forth in FIGS. 3A and 3B. The steps may be executed in different sequences to reach the end results discussed above.

Referring to FIG. 3A, the system waits in step 120 for a prepaid fuel discount card to be inserted in the card reader 54 (FIG. 1) on the fuel dispenser 50 and read by the CPU 57. Once a magnetic strip or an embedded chip is read the CPU 57, the account information is sent to the central server 70 by way of the transceiver 61 in step 122 (FIG. 3A). The account information is received by the transceiver 82 at the central server 70. The CPU 84 in the central server 70 reads the account number and checks in step 124 whether the purchaser's account is valid. If the purchaser's account is not valid, the central server 70 signals the electronic control system 53 (FIG. 1B) that the purchaser's account is not valid in step 124. Upon receipt of this information, the electronic control system 53 returns to step 120 and awaits a prepaid fuel discount card to be inserted into the magnetic card reader 54 on the fuel dispenser 50 (FIG. 1). The CPU 57 may also send data to the display 51 or 52 on the fuel dispenser 50 indicating “Account Not Valid”.

If the purchaser's account is valid, the CPU 84 in the central server 70 recalculates the unit retail fuel price, as discussed below, and transmits it back to the fuel dispenser 50. In step 126, the transceiver 61 in the electronic fuel system 53 (FIG. 1B), the following information may be transmitted to the server 70 concerning the transaction in step 126.
Location of Fuel Dispenser
Grade selected by purchaser
Current retail price per gallon
Number of gallons pumped
Transaction complete

As mentioned above, the server 70 recalculates the retail price per gallon based upon the grade selected and the purchaser's locked in wholesale price component. The CPU 57 in the electronic control system awaits the response from the central server 70 in step 128. Once the response is received, the discounted retail price may optionally be written to the displays 58, 60 and 62 by way of the CPU 57 in step 129. In step 130, the electric motor 72 and electrically controlled valves 76 (FIG. 1B) are enabled up to maximum number of gallons based upon the discounted retail fuel price and the balance in the purchaser's account under the control of the manual lever (not shown) in the handle 57.

Alternatively, the fuel dispenser 50 is disabled from pumping fuel when the handle 57 (FIG. 1A) is hung up in the holster 59 in on the fuel dispenser housing 71. Once the handle 57 is hung up in the holster 59, the electronic control system 53 transmits a transaction complete signal to the central server 70 in step 132 and returns to step 120.

An exemplary flow chart for the central server 70 is illustrated in FIGS. 3B and 3C. Initially, the central server 70 awaits purchaser account information from the electronic control system 53 (FIG. 1B) in step 140. Once the purchaser's account information is received, the CPU 84 looks up the purchaser's account data in the purchasers account database 90 in step 142 and determines if the purchaser's account is valid in step 143. If the purchaser's account is not valid, a signal indicating the same is sent to the CPU 70 in the electronic control system 53 in step 144. The CPU 84 then returns to step 140.

If the purchasers account is valid, as determined in step 144, the CPU 84 looks up the date of purchase of the prepaid fuel discount card from the purchaser's account database 90. The CPU 84 utilizes that date to access the snapshot of wholesale price components existing on the date of purchase of the prepaid fuel discount card from the wholesale price database 88. To determine the wholesale price component at the fuel dispenser 50 where delivery is taken, the CPU 84 utilizes the location data received from the electronic control system 53 (FIG. 1B) and determines the undiscounted wholesale price component of the retail gas price on the date of the snapshot in step 146.

The CPU 84 also accesses the purchaser's account data from the purchasers account data base 90 to determine the amount and type of discount assigned to the purchaser's account. The CPU 84 also determines the average weighted wholesale price component based upon the discounted wholesale price components existing at the times of multiple prepayments This data is used to calculate a discounted retail price, as discussed above, based upon the existing per unit retail price received from the fuel dispenser 50, the undiscounted wholesale price component existing at the time the prepaid fuel card was purchased received from the wholesale price database 88, and an average weighted discounted wholesale price component. The average weighted discounted wholesale price component is used to arrive at a discounted retail price in step 148, as discussed above.

In step 150, the CPU 84 determines the maximum number of units of fuel that can be delivered to the purchaser based upon the discounted retail price and the balance in the purchaser's account. In step 152, the discounted unit retail fuel price is transmitted to the fuel dispenser in step 152 along with an ON signal that is applied to the on/off control subsystem 78 to enable the electric system 55 in step 154.

Both the CPU 57 in the electronic control system 53 and the CPU 84 in the central server 70 monitor the number of gallons pumped based on data received from the fuel dispenser 50 in step 156. If the maximum number of gallons is reached, the central server 70 generates an OFF signal that is applied to the on/off control subsystem 78 to disable the electric system 55 (FIG. 1B) in step 158. Subsequently, the CPU 84 debits the purchaser's account in step 160 for the number of gallons pumped The CPU 84 provides a running total of the number of gallons and the cost of the gallons pumped for display on the on the display 51 (FIG. 1) The central server 70 monitors a transaction complete signal from the fuel dispenser in step 162. If a transaction complete signal is received, the system goes to step 158.

Periodically, for example, monthly, the system processes a monthly statement to be sent to the purchaser, as indicated in step 161. The statement will illustrate the actual charges for the gas for each purchase, i.e. charges with the discount applied. The statement will also include the balance in the account based upon prepayments that are segregated including any additional deposits and allocations, i.e. debits, since the last statement.

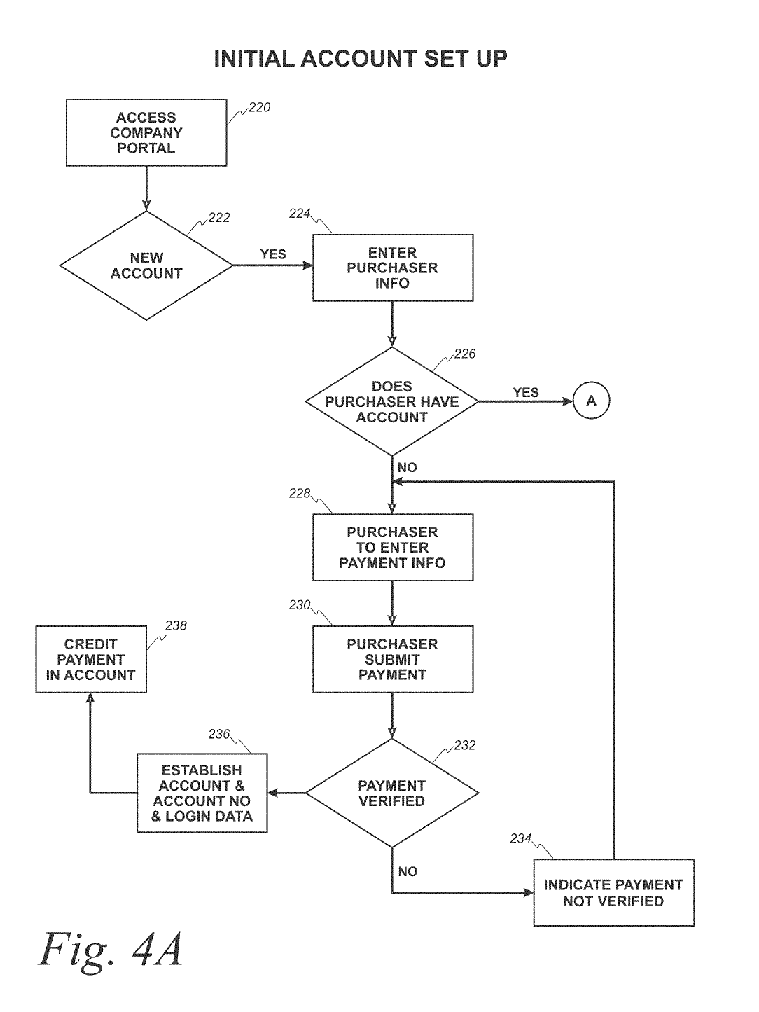

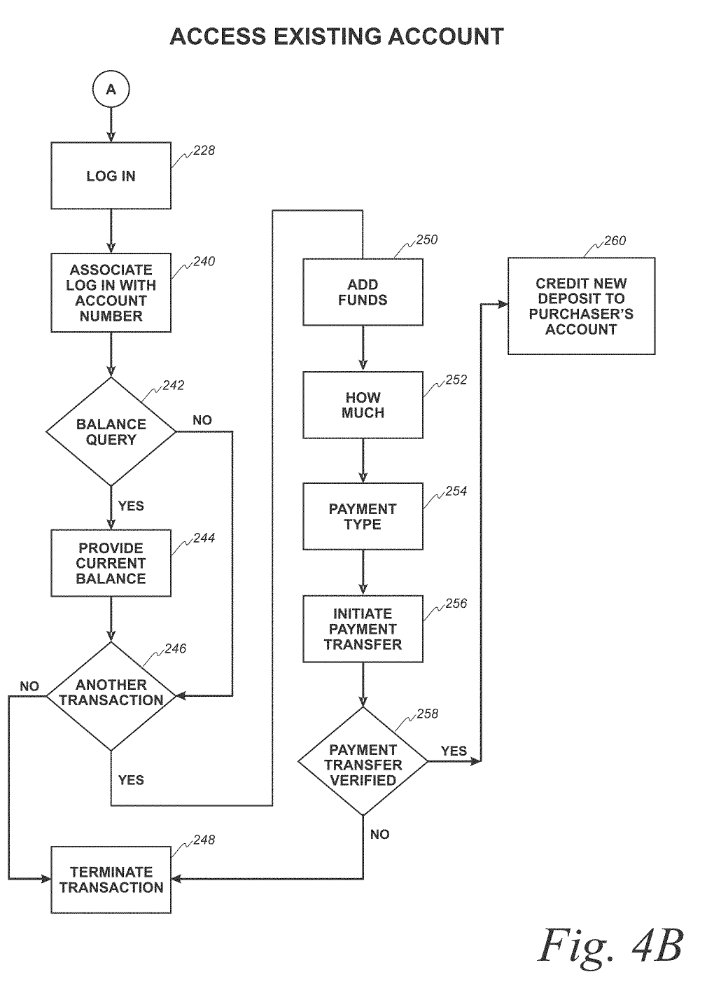

FIGS. 4A & 4B illustrate an optional aspect of the invention which relates to a payment allocation system which enables a purchaser to make multiple prepaid deposits of different amounts at different times in which the wholesale price components may vary and pay for gas deliveries with a weighted average of those wholesale price components.

The best way to understand the payment allocation system is by way of an example below. The table below lists three deposits at different wholesale price component discounts. As used below, the prices refer to wholesale price components per gallon.

| | | | Locked in | | | Wghtd. Disc. | | |
|---|---|---|---|---|---|---|---|---|
| | Date Of | Amt. of | Whol. Price | % | Disc. Whol. | Whol. Price/ | Date of | $ Amt of |
| Bal. | Dep. | Dep. | per Gallon | Disc. | Price | gallon | Con. | Con. |
| 150 | Jan. 5, 2017 | 150 | 2.50 | 20% | 2.00 | 2.00 | | |
| 110 | | | | | | 2.00 | Jan. 9, 2017 | 40 |
| 80 | | | | | | 2.00 | Jan. 15, 2017 | 30 |
| 280 | Jan. 20, 2017 | 200 | 2.80 | 25% | 2.10 | 2.0714 | | |
| 245 | | | | | | 2.0714 | Feb. 2, 2017 | 35 |
| 220 | | | | | | 2.0714 | Feb. 8, 2017 | 25 |
| 175 | | | | | | 2.0714 | Feb. 11, 2017 | 45 |
| 125 | | | | | | 2.0714 | Feb. 17, 2017 | 50 |
| 425 | Feb. 20, 2017 | 300 | 2.30 | 15% | 1.955 | 1.9892 | | |
| 381 | | | | | | 1.9892 | Feb. 21, 2017 | 44 |
| 343 | | | | | | 1.9892 | Feb. 27, 2017 | 38 |
| 301 | | | | | | 1.9892 | Mar. 1, 2017 | 42 |
| 270 | | | | | | 1.9892 | Mar. 9, 2017 | 31 |

The columns in the table are described below.
Bal.: the current balance in the user's account.
Date of Dep.: the date the user deposited funds in the account.
Amt. of Dep.: the amount of funds the user deposited into their account
Locked in Whol. Price per gallon: the locked in wholesale price component per gallon at the time of deposit.
% Disc.: the percentage per gallon discount of the wholesale price component at the time of deposit.
Disc. Whol. Price: the discounted wholesale price component in dollars.
Wghtd. Disc. Whol. Price/gallon.: the weighted average of the wholesale price components as determined at each deposit.
Date of Con.: the date of consumption or the date the user takes delivery of gas.
$ Amt. of Con.: the dollar amount of consumption which includes the average weighted discounted wholesale price components per gallon+the local fees and local taxes multiplied by the number of gallons consumed.

As shown above, deposits were made on January 5, January 20 and February 20. As shown, the wholesale price components for each deposit varies from $2.30 to $2.80 per gallon. The system determines the weighted average wholesale price component per gallon after each deposit is made and discounted and uses that number to determine the discounted retail price per gallon, as discussed above. This discounted retail price per gallon may be displayed on the display 51 (FIG. 1A) along with the amount of the completed transaction. The purchaser's account is debited using this discounted retail price per gallon. When the transaction is complete, as determined by the on/off control system 78, the fuel dispenser 50 (FIG. 1B) transmits the number of gallons pumped to the server 70 to be debited from the purchaser's account and displayed on the display 51 (FIG. 1A).

Referring to the table, the average weighted wholesale price per gallon is calculated each time a deposit is made to the account. The average weighted wholesale price component for each deposit normally varies as subsequent deposits are made. With reference to the table, the average weighted wholesale price after the initial deposit is $2.00 per gallon. When the second deposit is made, $80 remained from the first deposit. Thus, the average weighted wholesale price component per gallon at the time of the second deposit is [($80×$2.00)+($200×$2.10)]/$280 yields a weighted average wholesale price component of $2.0714 per gallon. When the third deposit is made, the user's account has a balance of $125. The average weighted wholesale price component per gallon at the time of the third deposit is [($125×$2.0714)+($300×$1.955)]/$425 yields a weighted average wholesale price component of $1.9892 per gallon.

Exemplary flow diagrams are illustrated in FIGS. 4A and 4B for implementing the optional allocation aspect of the invention. Turning first to FIG. 4A, an exemplary method of setting up the payment allocation system is illustrated. Various methods are contemplated for setting up account. One such method is by way of a web-based portal 200. The portal allows purchasers to set up the payment allocation system make deposits and adjust the allocation option as desired, for example, by way of any Internet connected computing device, such as a smart phone.

Turning to FIG. 4A, in step 222, after the portal is accessed, the user is prompted whether a new account is being opened. If so, the purchaser's data is entered in step 224. Next, the system checks in step 226 whether the purchaser already has an account. If so, the purchaser is requested to log in to their existing account in step 228 (FIG. 4B). If not, the purchaser is requested to enter payment information in step 228 for the first deposit, such as direct bank transfer, credit card, debit card, PayPal, etc. and submit payment in step 230.

The system verifies the payment in step 232. If the payment is not verified, the system may post a note in step 234 indicating that the payment was not verified and return to step 228. If the payment is verified, the system proceeds to step 236 to establish account number and credit the payment to the account in step 238 and interactively set up log in credentials with the purchaser.

Referring first to FIG. 4B, the purchaser logs onto the portal in step 228. In step 240, the system associates the log in credentials with the purchaser's account number. In step 242, the system queries whether a balance inquiry is desired. If so, the purchaser's current balance is provided in step 244. If a balance inquiry is not requested, or alternatively if the current balances were requested and provided, the system proceeds to step 246 and queries whether another transaction is requested. If not, the transaction is terminated in step 248.

If another transaction is requested, the system proceeds to step 250 and assumes the purchaser desires to add funds. If the user indicates that funds are to be added, the system queries in step 252, the amount of the additional funds to be added to the account. In steps 254 and 256, the payment is initiated. In step 258, the payment transfer is verified. If it is not verified, the system proceeds to step 248 and terminates the transaction. If the payment is verified, the system proceeds to step 260 and credits the new deposit to the purchaser's account.

Deposits may made, for example, on-line by credit card, debit card, bank transfer, pay pal or other means. The average wholesale price component per gallon is determined, as discussed above and may be displayed, for example on the purchaser's smart phone.

Obviously, many modifications and variations of the present invention are possible considering the above teachings. Thus, it is to be understood that, within the scope of the appended claims, the invention may be practiced otherwise than as specifically described above.

1. A wholesale fuel discount system for enabling a supplier to provide a fuel discount only on a wholesale price component of a retail price of a unit of fuel based upon a location of delivery of the fuel and a purchaser's account information, the system comprising:
a fuel dispenser including a mechanical system which includes an electric system and a mechanical system, the system comprising
a pump for pumping fuel;
an electric motor for driving said pump;
at least one electrically controlled valve; and
an ON/OFF control subsystem for selectively enabling said electric system; and
an electronic control system comprising:
a magnetic card reader for reading a magnetic strip or chip on a prepaid wholesale fuel discount card that provides a purchaser with a discount on a wholesale price component of a per unit retail fuel price for a grade of fuel, said magnetic strip or chip including the purchaser's account information;
a bidirectional communication subsystem for transmitting information to an external central server including the location of the fuel dispenser where fuel is being delivered, the purchaser's account information, an undiscounted retail price at the fuel dispenser where fuel is being delivered, a number of gallons pumped and a transaction complete signal and receiving information from said external central server regarding a discounted retail price based upon a discounted wholesale price component and ON/OFF signals for turning on the electric system up to an amount of cash credit in a purchaser's account based upon the discounted retail price per gallon;
an external central server in communication with said electronic control system in said fuel dispenser, said external central server configured to receive information from said electronic control system including the location of the fuel dispenser, the number of gallons pumped, the undiscounted retail price at the fuel dispenser where fuel is delivered, and a purchaser's account information, said external central server further configured to obtain information from a purchasers database including the amount of discount of the wholesale price component assigned to the purchaser's account and obtain information from a wholesale price database regarding the undiscounted wholesale price component at a location of the fuel dispenser at a place of delivery but at the time the prepaid fuel discount card was is purchased, said external central server configured to use the information to calculate a discounted wholesale price component and discounted retail per unit price based upon said discounted wholesale price component and transmit the discounted per unit retail price to the electronic control system in the fuel dispenser; and
a payment allocation system which enables a purchaser to make deposits associated with locked in wholesale price components for future purchases, wherein said external central server determines the average weighted wholesale price component per gallon and uses that number to determine the discounted unit retail price.

2. The wholesale fuel discount system as recited in claim 1, wherein said discounted retail per unit price is equal to the undiscounted retail price minus the undiscounted wholesale unit price component plus the discounted unit wholesale price component.

3. The wholesale fuel discount system as recited in claim 1, wherein said external central server takes a snapshot of all wholesale unit fuel price components existing at fuel dispensers across a region at the time the prepaid wholesale discount card is purchased and applies a wholesale fuel discount to the wholesale price component existing at fuel dispenser at the location of delivery at the time of purchase of the prepaid wholesale discount card.

4. The wholesale fuel discount system as recited in claim 1, wherein said external central server takes a snapshot of all the wholesale fuel price components for a selected grade of gasoline existing across the region at a specified time and applies a wholesale fuel discount to the wholesale price component existing at fuel dispenser at the specified time.

5. The wholesale fuel discount system as recited in claim 1, wherein said discounted wholesale price is a percentage discount of the undiscounted wholesale price at the location of the fuel dispenser at the time of delivery.

6. The wholesale fuel discount system as recited in claim 4, wherein said region is the US.

7. The wholesale fuel discount system as recited in claim 1, wherein said prepaid wholesale discount card is only usable to purchase a specific brand of fuel.

8. The wholesale fuel discount system as recited in claim 1, wherein said fuel is selected from the group of (premium, midrange and regular grades).

9. The wholesale fuel discount system as recited in claim 1, wherein said payment allocation system is accessible on-line.

10. The wholesale fuel discount system as recited in claim 9, wherein said payment allocation system is accessible by way of a smart phone.
